(19) United States
(12) Patent Application Publication
(10) Pub. No.: US 2021/0170989 A1
(43) Pub. Date: Jun. 10, 2021

(54) Anti Theft Device for Open Air Compartment Vehicles

(71) Applicant: James Andrew Cameron, Billings, MT (US)

(72) Inventor: James Andrew Cameron, Billings, MT (US)

(21) Appl. No.: 17/247,366

(22) Filed: Dec. 9, 2020

Related U.S. Application Data
(60) Provisional application No. 62/945,717, filed on Dec. 9, 2019.

(51) Int. Cl. B60R 25/20; B60R 25/01; B60R 25/10; B60R 25/102; B60R 25/30

(52) U.S. Cl. CPC B60R 25/2018; B60R 25/01; B60R 2025/1013; B60R 25/102; B60R 25/30; B60R 25/1004

(57) ABSTRACT

The present invention is an apparatus that is an Anti Theft Device for Open Compartment Vehicles (OCV) wherein the logical and the proprietary hardware and software application combination of the apparatus offers control over electronically and physically locking the ignition, steering, and brake systems of an OCV, the unique automated combination of physical motion prevention based locking of the ignition, steering and braking systems integrated into the open air passenger vehicle with both automatic (to include, but not be limited to, passive engagement and/or activation of the system), physically activate-able, and remotely activate-able security measures offer many flexible options for greatly enhancing the security of an OCV enabling deterring theft by preventing the activation, movement, or use of the vehicle's motion control systems to include but not be limited to the steering and brake systems of the vehicle.

### TECHNICAL FIELD OF THE INVENTION

The present disclosure and field of invention generally relates to systems for preventing or indicating unauthorized use or theft of vehicles. Specifically the present invention is an anti-theft device which will lock any one or all of the following systems on/of a two or more wheeled all-terrain, utility, or other open passenger compartment vehicle: the ignition system, the hand or emergency brake system, and/or steering system. Other purposes and benefits of the invention will be discovered through description and illustration herein.

### BACKGROUND

The present state of the art for alarm, disabling, and/or security of open passenger compartment vehicles (to include but not be limited to: motorcycles, tricycles, four wheelers, and all-terrain vehicles (ATV), and six-wheelers) is to use cumbersome mechanical locking devices to connect, chain, or otherwise tether the vehicle to something that is secure to help prevent theft; or to install a wireless transmitter, LoJack, or other global positioning system (GPS) device integrated so as to track the location of the vehicle for recovery purposes after it has been stolen.

The prior art is mostly focused on conventional passenger automobiles and or trucking vehicles with either no remote control capability, or a remote control using a paid (typically monthly) subscription service to maintain and monitor interconnectivity between the devices installed on the vehicle and a remote monitoring and/or disabling interface. Prior art examples of the physical locking type devices are shown in the following several patents which demonstrate the use of various physical barrier or motion prevention means by rod insertion type vehicle security system devices.

Refer to these four patents for physical locking devices: (1) U.S. Pat. No. 5,199,284 A, Lock Device for Steering Wheel in an Automobile, issued Apr. 6, 1993, to Lin wherein the steering wheel of the vehicle is locked with physical bar to secure the vehicle. (2) U.S. Pat. No. 5,520,033 A1, Vehicle Anti Theft Device, issued May 28, 1996, to Holmberg et al. wherein there is a vehicle anti theft device with lock rods is used to physically restrain and secure the accelerator of a vehicle in order to secure the vehicle and deter theft. (3) EP 0003238 A1, Method of locking and unlocking a mobile cargo container and a mobile cargo container lock, issued Dec. 12, 1978, to Barnes wherein an electro mechanical lock with remote switch is installed to secure a trucking trailer's doors remotely as an anti theft device to deter and prevent theft. And, (4) U.S. Pat. No. 6,499,324 B2, Automobile Anti Theft System, issued Dec. 31, 2002, Reeb et al., wherein there is an actuator installed inline with the accelerator of an automobile and a remote control activates the actuator preventing theft by preventing the accelerator from being depressed.

No prior art patents exist that utilize the sophistication of standalone Bluetooth, or digital keypad input to secure an open passenger compartment recreational vehicle using electronic or electro-mechanical physical locks to prevent the use or motion of the vehicle by locking the ignition, brake, and/or steering mechanisms of the vehicle. It is therefore the objective of the present invention to integrate standalone electro-mechanical actuators, lock-out relays, and a sophisticated standalone electronic access technology without a recurring service fee.

The immediate object of this invention is a novel approach to a huge theft issue in the open passenger compartment recreational vehicles. Using the Polaris Slingshot as an example, the device of the present invention will be installed with a lock-out relay to the ignition system, and electro-mechanical lockout devices to the hand brake, steering wheel, and/or ignition systems. The lock-out relay-central control system is any intelligent integrated circuit board computer processing system with a computer processing chip(s) and programmable read only memory, and random access memory onboard (any fully programmable and/or controllable mini-computer). Activation of the device can be signaled from any Bluetooth enabled device or by using the keypad. The vehicle is thereby locked and disabled by implementing layered deterrence of the ignition module locked out, the steering system locked, and the brake locked, and it is therefore exceedingly difficult to roll the vehicle away. The vehicle is enabled by input of a digital code on the keypad, proximity of an integrated radio frequency interface, use of the ignition system, and/or the proximity of an authorized Bluetooth connectable device.

Refer to the following two patent publications for remote control of locks: (1) US Patent Publication Number 2010/0201536A1, “System and Method for Accessing a structure using a Mobile Device,” by Robertson, et al., Aug. 12, 2010, and (2) US Patent Publication Number 2016/0241999 A1, “Cross Platform Automated Perimeter Access Control System and Method of Adopting Selective Adapter,” by Chin, et al., Aug. 18, 2016.

In light of the foregoing prior art, there is a need for an apparatus with ability to disable an open passenger compartment recreational vehicle and deter theft while it is unmonitored by locking ignition, steering, and braking systems as well as issuing alert signals both from detected motion of said open passenger compartment recreational vehicle, from a hidden switch, or remote triggering from a smart device.

### BRIEF SUMMARY OF THE INVENTION

According to a first aspect of the invention, there is a Anti Theft Device for Open Compartment Vehicles comprising an apparatus for electronically and physically securing an open compartment vehicle (OCV) comprising a central control unit connectively attached to and having operational control over a left speaker of said OCV, a right speaker of said OCV, an over-ride button installed on said OCV, a vehicle ignition system switch of said OCV, an ignition lockout relay of said OCV, a steering system locking device of said OCV, a brake system locking device of said OCV, a horn system of said OCV, a light system of said OCV, a LED light color indicator panel, a hidden communication range boost antenna, a camera, a microphone, a motion/bump sensor having an adjustable sensitivity, a visible communication range boosting antenna, a hidden switch, and a hood switch thereby enabling said OCV to have an electronic security and a physical security each having a plurality of theft deterrence means available from said central control unit comprising a lock having a disablement control of said vehicle ignition system switch of said OCV, said ignition lockout relay of said OCV, said steering system locking device of said OCV, and said brake system locking device of said OCV, thereby preventing said OCV from being stolen, started, steered, or rolled away, further enabling activation of an alert signal emission via any of said left speaker, said right speaker, said LED light color indicator panel, and said horn/light system in response to a trigger signal received from any of said visible communication range boosting antenna, said over-ride button, said hood switch, said hidden antenna to boost signal range, said camera, said microphone, and said motion/bump sensor thereby creating an audial and visual alert of a potential theft, and a remote control means comprising a keypad, and a programmable wireless user access device software application enabled and configured to lock and disable said theft deterrence means and to enable a trigger signal to emit said alert signal thereby enabling a layered deterrence security alarm system for said OCV by providing a stand alone and autonomous theft deterrence without a fee or subscription service necessary.

According to a second aspect of the invention, there is an Anti Theft Device for Open Compartment Vehicles comprising an apparatus for electronically and physically securing an open compartment vehicle (OCV) comprising a central control unit connectively attached to and having operational control over a left speaker of said OCV, a right speaker of said OCV, an over-ride button installed on said OCV, a vehicle ignition system switch of said OCV, an ignition lockout relay of said OCV, a steering system locking device of said OCV, a brake system locking device of said OCV, a horn system of said OCV, a light system of said OCV, a navigation system of said OCV, a LED light color indicator panel, a hidden communication range boost antenna, a camera, a microphone, a motion/bump sensor having an adjustable sensitivity, a visible communication range boosting antenna, a hidden switch, and a hood switch thereby enabling said OCV to have an electronic security and a physical security each having a plurality of theft deterrence means available from said central control unit comprising a lock having a disablement control of said vehicle ignition system switch of said OCV, said ignition lockout relay of said OCV, said steering system locking device of said OCV, and said brake system locking device of said OCV, thereby preventing said OCV from being stolen, started, steered, or rolled away, further enabling activation of an alert signal emission via any of said left speaker, said right speaker, said LED light color indicator panel, said horn system, said light system, and said navigation system in response to a trigger signal received from any of said visible communication range boosting antenna, said over-ride button, said hood switch, said hidden antenna to boost signal range, said camera, said microphone, and said motion/bump sensor thereby creating an audial and visual alert of a potential theft, and a remote control means comprising a keypad, and a programmable wireless user access device software application enabled and configured to lock and disable said theft deterrence means and to enable a trigger signal to emit said alert signal thereby enabling a layered deterrence security alarm system for said OCV by providing a stand alone and autonomous theft deterrence without a fee or subscription service necessary.

According to a third aspect of the invention, there is an Anti Theft Device for Open Compartment Vehicles, wherein said OCV further comprises a brake switch and a clutch switch, and wherein said theft deterrence means further comprises a lock having a disablement control of said brake switch and said clutch switch.

According to a fourth aspect of the invention, there is an Anti Theft Device for Open Compartment Vehicles, further comprising a tamper deterrence means comprising an activation of said alert signal when said trigger signal is received, when a control signal is received from said theft deterrence means, or when an alert signal is received from said programmable wireless user access device that enables the activation of the apparatus thereby preventing said OCV from being stolen, started, steered, or rolled away.

According to a fifth aspect of the invention, there is an Anti Theft Device for Open Compartment Vehicles, further comprising an auto-activation feature configured to enable the automatic activation of said theft deterrent means to prevent theft of said OCV when a user does not affirmatively engage the system with a trigger signal from the hidden switch or the remote control means configured.

According to a sixth aspect of the invention, there is an Anti Theft Device for Open Compartment Vehicles, further comprising an alert signal having the form of an automated announcement, or voice call to an emergency response service.

The invention will now be described, by way of example only, with reference to the accompanying drawings in which:

### BRIEF DESCRIPTION OF THE DRAWINGS

FIG. 1 is of a Polaris Slingshot Design Solution. FIG. 1 is a diagram showing an embodiment of the present invention for a Polaris Slingshot Open Passenger Compartment vehicle.

### DETAILED DESCRIPTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

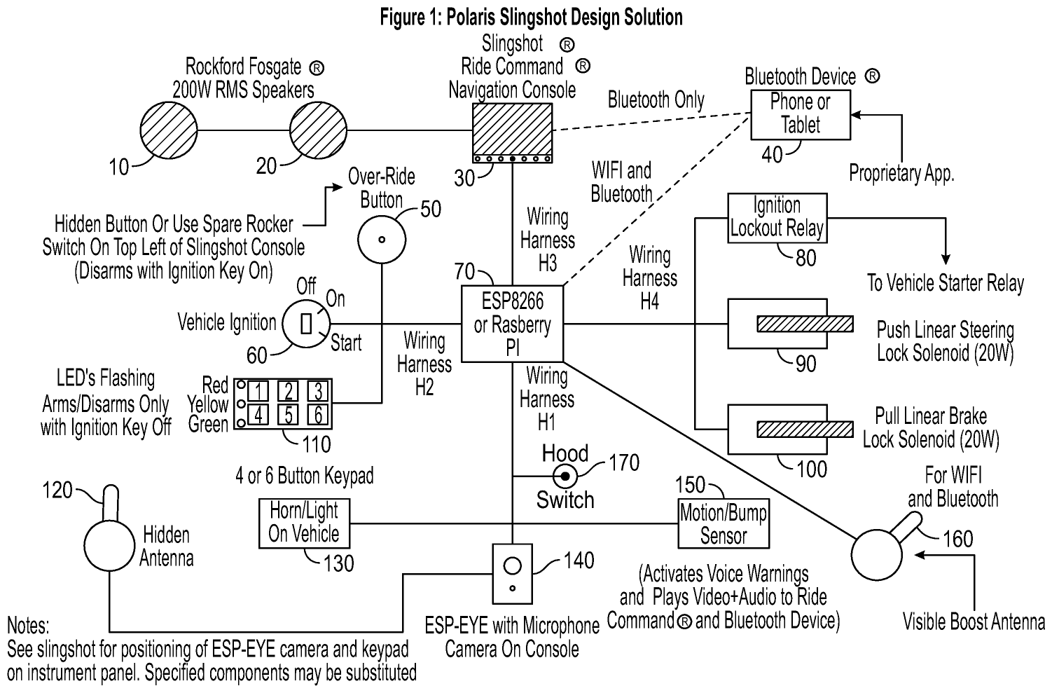

Referring to the FIGURES, there is shown in FIG. 1 a Polaris Slingshot Design Solution as a diagram showing an embodiment of the present invention for a Polaris Slingshot Open Passenger Compartment vehicle. Shown in FIG. 1, are the following elements by number as indicated in the diagram: 10—left speaker of the vehicle; 20—right speaker of the vehicle; 30—navigation/GPS console of the vehicle; 40—an owner/users cell phone or tablet with bluetooth connectivity (programmable wireless user access device); 50—over-ride button installed on vehicle ignition system; 60—vehicle ignition system switch; 70—central control unit—a remotely controllable device capable of sending and receiving signals to the physical interlocks; 80—ignition lock out relay of the vehicle; 90—steering system locking device; 100—brake system locking device; 110—LED light color indicator panel; 120—hidden antenna; 130—horn/light system of the vehicle; 140—camera with microphone; 150—motion/bump sensor; 160—visible antenna.

The present invention is an Anti Theft Device for Open Compartment Vehicles wherein the logical (the proprietary hardware/software(app) combo) control over physically locking by electro-mechanical means the steering and brake systems as far as the embodiment and current implementation is proceeding. This unique automated combination of physical/motion prevention based locking of the steering and braking systems integrated into the open air passenger vehicle with both automatic (to include passive engagement/activation of the system), physically activate-able, and remotely activate-able security measures offers many flexible options for greatly enhancing the security of the vehicle by deterring theft by preventing the activation, movement, or use of the vehicle's motion control systems to include but not be limited to the steering and brake systems of the vehicle.

The Vehicle Anti Theft Device of the present invention is comprised of a plurality of electro-mechanical actuators, or other interlocking/locking devices, connectively attached to a computerized central control/processing unit with an authorized/synchronized/paired radio wave communication remote device (app, smartphone, tablet, etcetera) which is a remotely controllable device capable of sending and receiving signals to the locks/interlocks of the system for their operation to secure/un-secure (arm/disarm) the vehicle. The computerized central control/processing unit, the wireless remote control devices, and associated applications therein/thereon are controlled by the software control sequence coded into the computerized central control/processing unit so as to provide the features and functions herein described, as well as to offer the user the capability to change the settings of the control device or to switch control devices or methods. The device of the present invention is used to prevent theft by permitting the owner of an open air passenger compartment vehicle to physically lock and restrict the use of the various vehicle control system components of the vehicle.

While any vehicle control system with sufficient control over the operation of the vehicle may be physically locked with an actuator, bar, or other physical barrier, the present invention's preferred embodiment focuses on the vehicle movement control systems to include: the ignition system, steering, clutch, and brake systems of a given vehicle.

The electro-mechanical actuators and/or other locking methods are installed inline with the vehicle control system on a given vehicle. By installing a physical lock, interlock, and/or system operation interruption device inline with a vehicle control system, the vehicle owner can effectively disable or enable that control system. Control systems include, not less than, the ignition system, steering, brake, and clutch systems

For example, an electro-mechanical actuator is installed inline/into the operational path of the steering control system such that when the actuator is extended it inhibits the motion of the steering control system for the vehicle. The actuator is operably connected to the control device of the present invention. Thus, when the control device sends the appropriate signal to either lock or unlock the control system the actuator locks or unlocks the steering control system.

Similarly electro-mechanical devices (actuators, or any other suitable physical blocking/locking method or other control system interruption method) are installed inline/into the braking, acceleration, and/or ignition control systems of the vehicle to be protected. Each control system interruption method is connected to, or attached to, the control system for control of the locking method. Thus, when the control device sends the appropriate signal to either lock or unlock the control system, the installed control system interruption method locks or unlocks that control system.

Installing interruption methods into/inline with the ignition system, steering, and brake control systems of a vehicle and connecting them to the control system thus enables a vehicle owner to lock and unlock the operation of any one or any combination of the connected interruption methods thus enabling them thereby preventing the starting, steering, release of braking until another signal is sent by the owner to unlock and return to operation to the disabled control systems of the vehicle.

The present invention using these devices provides a multi-layer approach to vehicle immobilization. The elements, components, and other installed parts are hidden and not easily accessible to the average person. It would take a person of above average mechanical skill considerable time to find, electronically trace, and even access the location of these various devices and defeat them.

The important, novel, unique, and useful features of the present invention include, but are not limited, to the following benefits:

A major benefit of this invention is the ability to disable your open passenger compartment recreational vehicle and deter theft while it is unmonitored. Disabling of the vehicle is provided by the features and functions of the software/application coded into the central control unit (70) which is programmed to lock/interlock the various operation and motion control systems and components of the vehicle as to prevent its rolling, steering, or movement from its parked, armed, and disabled position.

Another useful benefit of this invention is remote activation of the horn, camera, voice warnings, and lights if you see persons tampering with the open passenger compartment recreational vehicle. The central control unit (70) is programmed to permit the remote activation of the horn/lights/speakers/etcetera of the vehicle for this express purpose.

A third unique and useful benefit of this invention is it disallows unauthorized use of your open passenger compartment recreational vehicle. Disabling of the vehicle is provided by the features and functions of the software/application coded into the central control unit (70) which is programmed to lock/interlock the various operation and motion control systems and components of the vehicle as to prevent its rolling, steering, or movement from its parked, armed, and disabled position.

A fourth unique benefit of this invention is the concurrent locking of all drive, steering, and starting modalities and systems of the open passenger compartment recreational vehicle. The central control unit (70) is programmed to enable the remote activation of the plurality of vehicle control systems, to include all such systems or components, of the vehicle used for its operation/motion/mobility.

A fifth unique benefit of this invention is multilayered deterrents which a thief would have to overcome in order to steal the open passenger compartment recreational vehicle. As the device/systems of the present invention has the capacity to lock/interlock any/all vehicle operation/motion/mobility control systems, there are multiple layers of theft deterrent built into this system/device/invention.

A sixth benefit of this invention is tamper deterrence in that the system activates the vehicle's lights, voice warnings, horn, video, and others as appropriate if the wires, keypad, actuators, or other components are tampered with. The central control unit (70) is programmed to enable the remote or automatic activation of the vehicle's lights, voice warnings, horn, video, and others as appropriate if the wires, keypad, actuators, or other components are tampered with.

A seventh major benefit of this invention is there are no monthly service fees associated with use of the invention. The device/system of the present invention is stand alone and autonomous and provides its full utility without a fee or subscription service necessary.

An eighth benefit of this invention is the auto-activation feature. Once installed the device of the present invention as programmed permits/enables the automatic activation of the securing locks of the vehicle's control systems to prevent theft in the event the owner does not affirmatively engage the system with a signal from the hidden switch or the remote control means configured.

A ninth benefit of the present invention is the sensitivity programmable bump sensor and a hood switch that will activate the alarm and defeat the other locking modules.

Further, the device of the present invention allows the vehicle owner the option of horn/lights, audio/video record, or “voice warning/lights” interfaces to permit the announcement of the operation and/or status of the present invention's control over the vehicle into/onto which the invention has been installed, as well as any other suitable warning or announcement to be made when an installed sensor indicates a change condition such as a bump or motion sense, or unauthorized opening of the vehicle's engine compartment. For example, where a motion sensor is installed into/onto the vehicle that is connectively interfaced with the control system of the present invention, when change of condition is detected, a custom recorded or standard verbal warning/announcement can be made to let a person who caused the change of condition to receive a signal that the invention is operational and the vehicle has been secured so as to prevent its unauthorized operation and/or theft. Pre-recorded and stored and or custom voice warnings in the firmware and software can be used for the warning/announcement, as can any suitable tone or other auditory signal.

A typical bump sensor activating sequence would be the following; First, lights and horn. Second, a standard or a custom recorded verbal warning through the sound system “Stop, the police have been notified and you are being recorded and monitored by the owner of this vehicle.” Third, the camera activates and displays to the Ride Command screen the “bad guy” and sends the same to the owner's phone via Wifi (if available) or defaults to Bluetooth if not. Fourth back to horn and lights; And repeat.

Further, the present invention can be integrated into the instrument, navigation or other computer control systems installed on a given vehicle. Integration of/into the instrument, navigation, or other computer control system while possible is not required. Where the present invention is configured to interface with the instrument, navigation or other computer control systems installed on a given vehicle, control over the anti-theft capabilities of the present invention can be provided by use of these vehicle computer control systems.

Note, the boost antenna gives far greater range to Bluetooth communication than would be without the boost antenna. The system will attempt to use open Wifi networks to communicate with the owner's Phone or Tablet device anywhere in the world. And if no Wifi is available, it will default to the more limited Bluetooth. Even if it is somehow stolen, the moment it comes into range of open Wifi, it will talk to the owner.

In an embodiment of the invention, there is an Anti Theft Device for Open Compartment Vehicles comprising an apparatus for electronically and physically securing an open compartment vehicle (OCV) comprising a central control unit connectively attached to and having operational control over a left speaker of said OCV, a right speaker of said OCV, an over-ride button installed on said OCV, a vehicle ignition system switch of said OCV, an ignition lockout relay of said OCV, a steering system locking device of said OCV, a brake system locking device of said OCV, a horn system of said OCV, a light system of said OCV, a LED light color indicator panel, a hidden communication range boost antenna, a camera, a microphone, a motion/bump sensor having an adjustable sensitivity, a visible communication range boosting antenna, a hidden switch, and a hood switch thereby enabling said OCV to have an electronic security and a physical security each having a plurality of theft deterrence means available from said central control unit comprising a lock having a disablement control of said vehicle ignition system switch of said OCV, said ignition lockout relay of said OCV, said steering system locking device of said OCV, and said brake system locking device of said OCV, thereby preventing said OCV from being stolen, started, steered, or rolled away, further enabling activation of an alert signal emission via any of said left speaker, said right speaker, said LED light color indicator panel, and said horn/light system in response to a trigger signal received from any of said visible communication range boosting antenna, said over-ride button, said hood switch, said hidden antenna to boost signal range, said camera, said microphone, and said motion/bump sensor thereby creating an audial and visual alert of a potential theft, and a remote control means comprising a keypad, and a programmable wireless user access device software application enabled and configured to lock and disable said theft deterrence means and to enable a trigger signal to emit said alert signal thereby enabling a layered deterrence security alarm system for said OCV by providing a stand alone and autonomous theft deterrence without a fee or subscription service necessary.

In a preferred embodiment of the invention, there is an Anti Theft Device for Open Compartment Vehicles comprising an apparatus for electronically and physically securing an open compartment vehicle (OCV) comprising a central control unit connectively attached to and having operational control over a left speaker of said OCV, a right speaker of said OCV, an over-ride button installed on said OCV, a vehicle ignition system switch of said OCV, an ignition lockout relay of said OCV, a steering system locking device of said OCV, a brake system locking device of said OCV, a horn system of said OCV, a light system of said OCV, a navigation system of said OCV, a LED light color indicator panel, a hidden communication range boost antenna, a camera, a microphone, a motion/bump sensor having an adjustable sensitivity, a visible communication range boosting antenna, a hidden switch, and a hood switch thereby enabling said OCV to have an electronic security and a physical security each having a plurality of theft deterrence means available from said central control unit comprising a lock having a disablement control of said vehicle ignition system switch of said OCV, said ignition lockout relay of said OCV, said steering system locking device of said OCV, and said brake system locking device of said OCV, thereby preventing said OCV from being stolen, started, steered, or rolled away, further enabling activation of an alert signal emission via any of said left speaker, said right speaker, said LED light color indicator panel, said horn system, said light system, and said navigation system in response to a trigger signal received from any of said visible communication range boosting antenna, said over-ride button, said hood switch, said hidden antenna to boost signal range, said camera, said microphone, and said motion/bump sensor thereby creating an audial and visual alert of a potential theft, and a remote control means comprising a keypad, and a programmable wireless user access device software application enabled and configured to lock and disable said theft deterrence means and to enable a trigger signal to emit said alert signal thereby enabling a layered deterrence security alarm system for said OCV by providing a stand alone and autonomous theft deterrence without a fee or subscription service necessary.

In an embodiment of the invention, there is an Anti Theft Device for Open Compartment Vehicles, wherein said OCV further comprises a brake switch and a clutch switch, and wherein said theft deterrence means further comprises a lock having a disablement control of said brake switch and said clutch switch.

In an embodiment of the invention, there is an Anti Theft Device for Open Compartment Vehicles, further comprising a tamper deterrence means comprising an activation of said alert signal when said trigger signal is received, when a control signal is received from said theft deterrence means, or when an alert signal is received from said programmable wireless user access device that enables the activation of the apparatus thereby preventing said OCV from being stolen, started, steered, or rolled away.

In an embodiment of the invention, there is an Anti Theft Device for Open Compartment Vehicles, further comprising an auto-activation feature configured to enable the automatic activation of said theft deterrent means to prevent theft of said OCV when a user does not affirmatively engage the system with a trigger signal from the hidden switch or the remote control means configured.

In an embodiment of the invention, there is an Anti Theft Device for Open Compartment Vehicles, further comprising an alert signal having the form of an automated announcement, or voice call to an emergency response service.

It is noted that the phrase Open Compartment Vehicles (OCV) is intended include, but be not limited to, all terrain vehicle brands, three wheelers, motorcycles, four wheelers, all-terrain vehicles (ATV), utility vehicles, six wheelers, side-by-sides, utility vehicles or utility task vehicles, a recreational off-highway vehicles, or a multipurpose off-highway utility vehicles, marine equipment, while not specifically discussed at length herein, are included with the scope of vehicles whose owners could benefit from the use of the present invention. Further, it will be appreciated that the lack of those specifics is not intended to limit the invention to the precise form, scale, and description described or drawn herein. Any number of ATVs, motorcycles, trikes, four wheelers, six-wheelers, and any open passenger compartment recreational vehicles, etcetera may be the protected vehicle for which the present invention is adapted to provide theft protection. Naturally, the present invention may be embodied in other forms without departing from its spirit or essential characteristics.

The current best known embodiment is as shown in FIG. 1—Polaris Slingshot Design Solution—is a diagram showing the embodiment of the present invention for a Polaris Slingshot Vehicle. As shown in FIG. 1 are the following elements by number as indicated in the diagram: 10—left speaker of the vehicle; 20—right speaker of the vehicle; 30—navigation/GPS console of the vehicle; 40—an owner/user's cell phone or tablet with bluetooth connectivity; 50—over-ride button installed on vehicle; 60—vehicle ignition system switch; 70—central control unit—a remotely controllable device capable of sending and receiving signals to the physical interlocks; 80—ignition lock out relay of the vehicle; 90—steering system electro-mechanical locking device; 100—brake system electro-mechanical locking device; 110—LED light color indicator panel; 120—hidden antenna to boost signal range for Bluetooth signal exchange; 130—horn/light system of the vehicle; 140—camera with microphone; 150—motion/bump sensor; 160—visible communication range boosting antenna, 170—hood switch. Note: the hood switch (170) as shown in FIG. 1 could alternatively be a fuel line lock, or other vehicle system lock.

The central control unit (70) may consist of any integrated circuit logic board computer type control unit with the appropriate proprietary and customized firmware/software programmed into it in order to provide the features and functions herein described. This includes any suitable remotely controllable device capable of sending and receiving signals to said integrated circuit board which then signals the physical interlocks and all other components of the device of the present invention to act as the “brain” for providing control over the lock/interlocks implemented in the system.

The central control unit (70) controls the system, sends and receives signals from a remote controlling device such as a phone or tablet (40) with Bluetooth connectivity. The left (10) and right (20) speakers of the vehicle are connected with and signaled/controlled by the central control unit (70) through the navigation/GPS system (30) and can be signaled by the central control unit (70) through the Harness Connection H3 shown between the central control unit (70) and the navigation/GPS system (30).

An over-ride button (50) can be optionally installed on the vehicle, and is installed on the shown embodiment with the Polaris Slingshot ATV. The over-ride button (50), the vehicle ignition switch (60), and the LED indicator lights (110) are connected with and signaled/controlled by the central control unit via the Harness Logic Connection H2 shown between the central control unit (70) and the over-ride button (50), the vehicle ignition switch (60), and the LED indicator lights (110).

The hidden antenna (120), the horn/light relay (130) of the vehicle; the camera with microphone (140); the motion/bump sensor (150); and the hood switch (170) are connected with and signaled/controlled by the central control unit (70) via the Harness Logic Connection H1 shown between the central control unit (70) and the hidden antenna (120); the horn/light system (130) of the vehicle; the camera with microphone (140); and the motion/bump sensor (150). The visible antenna (160) and the hood switch (170) are connected directly to the central control unit (70).

The locks integrated into the vehicle's systems to include the ignition lock out relay (80), the steering system actuator locking device (90), and the brake system actuator locking device (100) are connected with and signaled/controlled by the central control unit (70) via the Harness Logic Connection H4 shown between the central control unit (70) and the ignition lock out relay (80), the steering system locking device (90), and the brake system locking device (100).

The instructions for using the present invention on the Polaris Slingshot ATV are provided below followed by the programming selections for the central control unit (70) as therein installed.

Polaris Sling Sentry Instructions and Programming Features:

Instructions for use:

Install the system on the vehicle.

Install the proprietary App on your Bluetooth Capable personal device.

Sync your device with the System using the Master Code. Keep the Master Code in a safe place.

Follow prompts and set your 4 or 6 digit access code.

Set all other programming selections and Sync with the system again.

Park the recreational vehicle.

Engage the recreational vehicle's security protection system by entering the digital code on the vehicle keypad, or activate the system using the Bluetooth device (cell phone or otherwise).

See flashing red LED indicator on keypad; the vehicle is locked and disabled.

Enable the vehicle by either: Turning the ignition key on and pressing the override button, turning the ignition key Off and entering your access code on the digital keypad, or using the Bluetooth app on your phone (Note: You do not have to have cell service to use the Bluetooth device features. You only need to be within Bluetooth range of the recreational vehicle).

See solid green LED indicator on keypad; the vehicle is unlocked and enabled.

You may activate the horn/lights, Voice Warnings, and/or Video/Audio Record on your recreational vehicle, by using the app on your Bluetooth device, if you are within Bluetooth range of the vehicle. This is helpful if you observe persons tampering with your vehicle or if you need to find your vehicle in a parking lot, in the dark, or in the woods. You may also activate a motion sensor with your Bluetooth device that will activate lights and horn if the vehicle is moved or bumped.

LED Indicators:

Red flashing slow—System is armed and vehicle is disabled.

Red & Yellow solid—Tamper Lockout. User code entered incorrectly 4 times.

Yellow flashing—User sequence error. Key is either “ON” or “OFF.”

Green solid—System is disarmed and vehicle is operational.

OPERATIONAL SEQUENCE NOTE 1: By design, the override button does not EVER arm the Sentry system. By design, the unmarked and stealthy override button does not disarm unless you turn the Key to “ON” and know where the button is and what it does in proper sequence; then you can start the engine and drive.

OPERATIONAL SEQUENCE NOTE 2: By design, the keypad can arm OR disarm the Sentry system. It is active when the key is not in the ignition and it is disabled when the vehicle ignition is turned “ON.”

THE OPERATIONAL SEQUENCE SUM BONUM: Hence, most of the time, when you get in, turn the key to “ON,” and press the override button, the Sentry system status light turns from red (armed) to green (disarmed). You start the vehicle and drive/enjoy, or, you are in the garage and need to roll back the Slingshot out of the way. You don't have the key on you. Simply enter the User code. The light changes from Red to Green and you can roll the vehicle. Enter the code again and the Sentry is activated. The light goes from Green to Red.

Or, you get in and don't want your teenage son to see that you can disable Sling Sentry by turning the key and pressing the “unmarked/spare/hidden” button on, or below, the dashboard. So you enter the keypad code first. The Sentry status LED turns from Red to Green. Start your vehicle and drive/enjoy.

Programming Selections:

App Password: User Specific

Device Sync Settings: User Specific

Auto Activation: Off, 15, 30, 60 seconds.

Override Button: Off, On, Double tap.

Factory Master Code: 0072020.

Programmable Access Code: 4 Digit User Code, 6 Digit User Code.

Alarm Notification: Wifi Only, Bluetooth Only, or Wifi priority then Bluetooth.

Alarm Response: Lights/Horn, Voice warn 1, Voice warn 2, Voice Warn Custom.

Stealth Mode

Video Real Time Playback: Road Command Screen, Bluetooth Device, Both.

Record Custom Warning: Record, Playback, Save.

Rockford Fosgate Volume Setting: Low, Medium, High, Mute.

Bump Sensor Options: Low, Medium, High, or Disable.

Audio/Video Send: Video & Audio to Cloud, Video & Audio to Personal Device

Lockout Selections: Ignition Lockout, Brake Lockout, Steering Lockout, All

Instant ON video/audio recording: On, Off

GPS Notification when in Wifi: On, Off.

GPS Notification via Bluetooth: On, Off.

Tamper Lockout: Lockout for 15, 30, 1 hr. Override button also? YES, NO

Reserved for GPS interface

Reserved for GPS interface

Firmware/Software Update: Load, Are you Sure? YES, NO

End instructions for use of the present invention and programming selections available.

Although the invention has been explained in relation to a particular embodiment, it is to be understood that many other possible modifications and variations can be made without departing from the spirit and scope of the invention and used on any motorcycle, tricycle, four wheeler, and all-terrain vehicle, six-wheeler, or other open passenger compartment vehicle as desired.

All illustrations, drawings, and diagrams are for the purpose of describing the selected version of the present invention presented therein, and are not intended to limit the scope of the present invention in any material way.

Although the invention has been explained in relation to various embodiments, it is to be understood that many other possible modifications and variations can be made without departing from the spirit and scope of the invention.

While the invention has been described in a number of specific embodiments and their advantages have been described herein in detail, it should be understood that numerous and various changes, modifications, substitutions, configurations, and alterations will be readily apparent to those skilled in the art. These could be made without departing from the spirit of the invention and coverage as defined by the appended claims. Moreover, the potential applications of the disclosed techniques is not intended to be limited to the particular embodiments of the processes, machines, manufactures, means, methods and steps described herein.

As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized. Accordingly, the appended claims are intended to include, within their scope, such processes, machines, manufactures, means, methods or steps.

1. An apparatus for electronically and physically securing an open compartment vehicle (OCV) comprising a central control unit connectively attached to and having operational control over a left speaker of said OCV, a right speaker of said OCV, an over-ride button installed on said OCV, a vehicle ignition system switch of said OCV, an ignition lockout relay of said OCV, a steering system locking device of said OCV, a brake system locking device of said OCV, a horn system of said OCV, a light system of said OCV, a LED light color indicator panel, a hidden communication range boost antenna, a camera, a microphone, a motion/bump sensor having an adjustable sensitivity, a visible communication range boosting antenna, a hidden switch, and a hood switch thereby
enabling said OCV to have an electronic security and a physical security each having a plurality of theft deterrence means available from said central control unit comprising a lock having a disablement control of said vehicle ignition system switch of said OCV, said ignition lockout relay of said OCV, said steering system locking device of said OCV, and said brake system locking device of said OCV, thereby preventing said OCV from being stolen, started, steered, or rolled away, further
enabling activation of an alert signal emission via any of said left speaker, said right speaker, said LED light color indicator panel, and said horn/light system in response to a trigger signal received from any of said visible communication range boosting antenna, said over-ride button, said hood switch, said hidden antenna to boost signal range, said camera, said microphone, and said motion/bump sensor thereby creating an audial and visual alert of a potential theft, and
a remote control means comprising a keypad, and a programmable wireless user access device software application enabled and configured to lock and disable said theft deterrence means and to enable a trigger signal to emit said alert signal thereby enabling a layered deterrence security alarm system for said OCV by providing a stand alone and autonomous theft deterrence without a recurring fee or subscription service necessary.

2. The apparatus of claim 1, wherein said OCV further comprises a brake switch and a clutch switch, and wherein said theft deterrence means further comprises a lock having a disablement control of said brake switch and said clutch switch.

3. The apparatus of claim 1, further comprising a tamper deterrence means comprising an activation of said alert signal when said trigger signal is received, when a control signal is received from said theft deterrence means, or when an alert signal is received from said programmable wireless user access device that enables the activation of the apparatus thereby preventing said OCV from being stolen, started, steered, or rolled away.

4. The apparatus of claim 1, further comprising an auto-activation feature configured to enable the automatic activation of said theft deterrent means to prevent theft of said OCV when a user does not affirmatively engage the system with a trigger signal from the hidden switch or the remote control means configured.

5. The apparatus of claim 1, further comprising an alert signal having the form of an automated announcement, or voice call to an emergency response service.

6. An apparatus for electronically and physically securing an open compartment vehicle (OCV) comprising a central control unit connectively attached to and having operational control over a left speaker of said OCV, a right speaker of said OCV, an over-ride button installed on said OCV, a vehicle ignition system switch of said OCV, an ignition lockout relay of said OCV, a steering system locking device of said OCV, a brake system locking device of said OCV, a horn system of said OCV, a light system of said OCV, a navigation system of said OCV, a LED light color indicator panel, a hidden communication range boost antenna, a camera, a microphone, a motion/bump sensor having an adjustable sensitivity, a visible communication range boosting antenna, a hidden switch, and a hood switch thereby
enabling said OCV to have an electronic security and a physical security each having a plurality of theft deterrence means available from said central control unit comprising a lock having a disablement control of said vehicle ignition system switch of said OCV, said ignition lockout relay of said OCV, said steering system locking device of said OCV, and said brake system locking device of said OCV, thereby preventing said OCV from being stolen, started, steered, or rolled away, further
enabling activation of an alert signal emission via any of said left speaker, said right speaker, said LED light color indicator panel, said horn system, said light system, and said navigation system in response to a trigger signal received from any of said visible communication range boosting antenna, said over-ride button, said hood switch, said hidden antenna to boost signal range, said camera, said microphone, and said motion/bump sensor thereby creating an audial and visual alert of a potential theft, and
a remote control means comprising a keypad, and a programmable wireless user access device software application enabled and configured to lock and disable said theft deterrence means and to enable a trigger signal to emit said alert signal thereby enabling a layered deterrence security alarm system for said OCV by providing a stand alone and autonomous theft deterrence without a fee or subscription service necessary.

7. The apparatus of claim 6, wherein said OCV further comprises a brake switch and a clutch switch, and wherein said theft deterrence means further comprises a lock having a disablement control of said brake switch and said clutch switch.

8. The apparatus of claim 6, further comprising a tamper deterrence means comprising an activation of said alert signal when said trigger signal is received, when a control signal is received from said theft deterrence means, or when an alert signal is received from said programmable wireless user access device that enables the activation of the apparatus thereby preventing said OCV from being stolen, started, steered, or rolled away.

9. The apparatus of claim 6, further comprising an auto-activation feature configured to enable the automatic activation of said theft deterrent means to prevent theft of said OCV when a user does not affirmatively engage the system with a trigger signal from the hidden switch or the remote control means configured.

10. The apparatus of claim 6, further comprising an alert signal having the form of an automated announcement, or voice call to an emergency response service.
